(19) United States
(12) Patent Application Publication
(10) Pub. No.: US 2025/0078185 A1
(43) Pub. Date: Mar. 6, 2025

(54) METHOD AND SYSTEM TO DETECT PROPERTY STATUS CHANGES FOR AUTOMATING REACTIONARY PROCESSES

(71) Applicant: Gary W. Moore, Llano, TX (US)

(72) Inventor: Gary W. Moore, Llano, TX (US)

(21) Appl. No.: 18/239,637

(22) Filed: Aug. 29, 2023

(51) Int. Cl. G06Q 50/16

(52) U.S. Cl. CPC G06Q 50/163

(57) ABSTRACT

A method and system is disclosed to identify, locate, and track, missing personal property. The method is used to determine the status of personal property based on changing characteristics interpreted within in a search process for applying and automating conditional responses. The system is comprised of a membership database of a computer based processing system, a property listing database within the same or separate computer based processing system, a web-based client for system access, information transfers between subcomponents encompassing the system, and communication infrastructures to support access from across the internet. An accumulation of stored and processed data is distributed in accordance with algorithms prescribed by the system and assigned by listing members.

### FIELD OF THE INVENTION

The present invention relates to detection and recovery of missing property and more particularly to managing personal property information for identifying, locating, and tracking missing property.

### BACKGROUND

The availability of information on demand through the internet has permeated just about every aspect of our existence and perhaps, one should consider privacy risks when further integrating technology into our lives. In the field of security for example, one may be willing to give up some level of privacy for beneficial purposes. Benign as it may appear, one assumes computer programs and mobile device applications are used solely for the purposes for which they are installed; however, one must also consider the security risks involved with exposing personal information to the internet for the purposes of usefulness or convenience.

U.S. Pat. No. 7,653,625 submitted by Frankel, et al., granted Jan. 26, 2010 presents a method and apparatus related business model to provide, publish and maintain a database for stolen property through a service agency utilizing the internet to promote public awareness for the primary purpose of recovering missing property. Although multiple processes are presented for automating contacts, alerts, notifications, recovery systems, tracking systems, public awareness, interfaces to law enforcement, insurance companies, pawnshops, and e-commerce solutions, the method requires an automated initiator for activation. More specifically, the system lacks an internal data detecting means to permit automated processes to activate. Consequently, a person must be in possession of prior knowledge of a loss event to relay specific details to activate automated processes for the benefit of convenience. In addition, a recovery system website is used to search for stolen property and if found, an option to select an icon to indicate “missing property located” is available for collecting additional information that could lead to the recovery of missing property. However, to locate missing property, the automated initiator must first be achieved for missing property to be included in the stolen property database. When a property search fails to return a property listing, especially when a property owner is unaware of a loss event, the opportunity for recovery could be forever lost.

US Patent Application No. 2017/0041324 submitted by Ionutescu, et al. published Feb. 9, 2017 illustrates a system for managing personal property information in a database for transaction management. The system communicates with account owner databases to exchange personal identity and property information, e.g., law enforcement agencies, providers for transaction management services to merchants, financial services, payment service providers, and other sources of information. The system receives personal property information from account owners of a sending database to create personal property records. The system also provides parsed or extracted data reports to various account owners of a receiving database that may be required from a party to a transaction in order for that party to enter into certain types of transactions. However, the collection of personally identifiable information is unnecessary for managing stolen property or even transferring property between parties in most situations. A preferred method for managing personal property information would separate personally identifiable information from property records rather than parsing data from an ever increasing database of collected information to associate owner identity with personal property. Furthermore, it would be more advantageous to store property information in a memory, database, or data storage device, apart from ownership details stored in another memory, database, or data storage device, whereby one database is rendered useless without the other. The collection of personally identifiable information as part of a personal property information management system for managing property transactions may not be the best option for identifying, locating, tracking, or preventing the sale of missing property.

### Objects and Advantages

Accordingly, it is an object of the present invention to establish property status as an internal data detecting means to activate various processes.

Another object of the present invention to establish property status for characterizing an accumulation property status conditions to initiate various processes based on definable conditions.

Another object of the present invention is to extract property characteristics from an accumulation of separate property status conditions to indicate changes in property status.

Another object of the present invention is to integrate property status as a configurable component of a search process to initiate definable processes.

Still another object of the present invention is to initiate specific processes, calculated from specific property characteristics, to create a tracking system for managing property status information.

Another object of the present invention is to search for property status organized as searchable property listings.

Yet another object of the present invention is to employ property status to capture and store information about personal property.

Another object of the present invention is to reconfigure property status calculated from specific property characteristics to reflect status modifications detected through a search process.

Another object of the present invention is to manage personal property information through processes initiated from property status changes.

Another object of the present invention is to provide a means for establishing property status for obfuscating the association between personal property and property owners.

### BRIEF DESCRIPTION OF THE DRAWINGS

A better understanding of the subject matter of the application may be obtained when the following detailed description of embodiments of the present invention are considered in conjunction with the following drawings, in which:

FIG. 1 illustrates a method to process property status search requests to initiate specific processes based on changing elements introduced by the search process for producing an accurate representation of property status.

FIG. 2 is an illustration for procedural access to a system for establishing and maintaining memberships, creating and editing user profiles, creating and editing property listings, conducting property searches, managing property status, and transferring property ownership, for introducing property status as an automated initiator to manage personal property loss and recovery information.

FIG. 3 illustrates a method for implementing property status and how it can be used to adapt to changing status conditions based on status detection introduced by the search process.

FIG. 4 illustrates a method to create a property listing for establishing property status within a searchable memory, database, or data storage means.

FIG. 5 illustrates property characteristics of a search request to identify property that may or may not be registered in a system for determining property status.

### DETAILED DESCRIPTION OF THE DRAWINGS

In the following description, reference is made to the attached drawings and figures to form part of the disclosure for illustrating aspects of embodiments of the present invention. Therefore, it is to be understood that the present invention is not limited to the particular forms disclosed herein, but rather to convey an approach to how embodiments of the present invention may be recognized and incorporated.

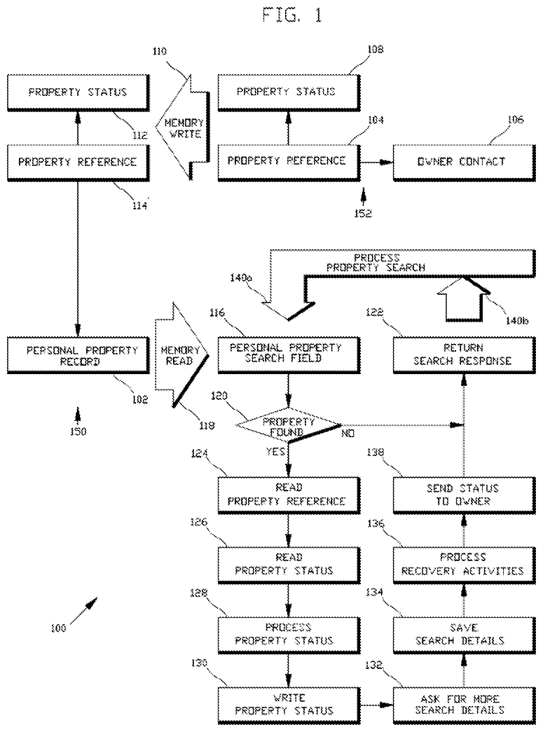

FIG. 1 is used to illustrate within a search means, relationships between an input means, a memory storage means, a processing means, and an output means to determine the status of personal property based on changing factors introduced by a search process for applying and automating conditional responses. The illustration encompasses a membership database 152 of a computer based processing system, a property listing database 150 within the same or separate computer based processing system, a web-based client for system access, information transfers between subcomponents comprising the system, and communication infrastructures to support access from across the internet 140.

A property record 102 is created by a listing member that includes a property reference 104 assigned by the system in relationship with contact 106 information and property status 108 stored in memory 110 of a property listing database 150. The property record is comprised of property status 112, a property reference 114 and a property listing 102. A search field 116 is populated from a search request140a to read 118 through property records 102 seeking a property match. If no match is found 120, a search reply 122 is returned to a search request 140b to indicate unregistered property. If however, a property match is found 120, then the property reference 124 and property status 126 are retrieved from memory 118 to interpret and process property status 128 that change due to a number of factors introduced later in the disclosure. The representation for current property status is an adaptation of logical considerations from assigned variables that are then updated and stored in memory 130 as a representation of accumulated status. As a component of logical considerations, the system assumes the search request was generated for property out of the possession of its owner and therefore changes property status 128. The search response 122 to the search request 140 produces an invitation for additional information 132 surrounding the search request and stores the information in memory 134 for recovery 136 purposes. The property owner 106 then receives all relevant information 138 surrounding the search request and the search request originator 140a receives property status 130 as the search response 122.

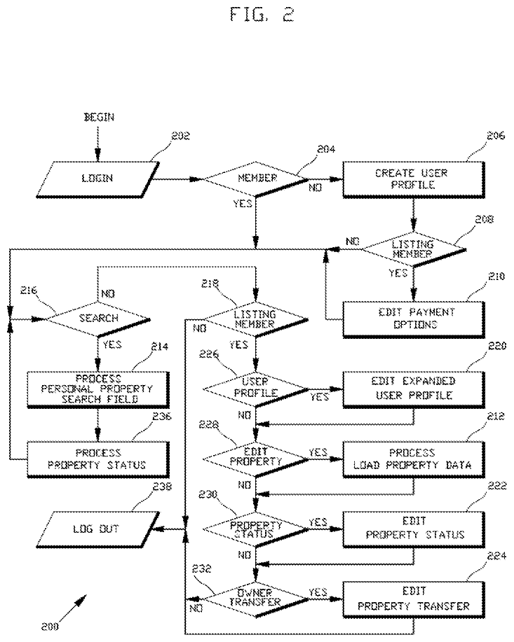

FIG. 2 is used to illustrate a method for procedural access to a system for establishing and maintaining membership, creating and editing user profiles, creating and editing property listings, conducting property searches, managing property status, and transferring property ownership for the purposes of managing personal property information seeking the recovery of missing property regarding property status. From a computer, smart device, mobile phone, or the like, access to the system requires a user login 202 through membership 204 employing a user profile 206 requiring no more than a method for contact to confirm user access. Listing members 208, who choose to register property through the system, must also provide a method of payment 210 that would also include various options to obfuscate the association between registered property 212 and property owners. Similarly, guest members 204 who choose to access the system solely to conduct property searches 214 may search for property status 216 without financial remuneration, bypassing 208 the need for payment options 210. For property listings identified through property search fields 214 within a search request, property status 236 is often modified based on additional factors introduced by the search process before initiating automated conditional responses. On the contrary, listing members 218 having a paid membership plan, enjoy selected benefits 226, 228, 230, and 232 offered through an expanded user profile 220 for listing property 212, creating and modifying property status 222, simplifying property transfers 224, receiving live status notifications, and directing property owner defined actions and processes. System access is terminated by logging out 238 of the system.

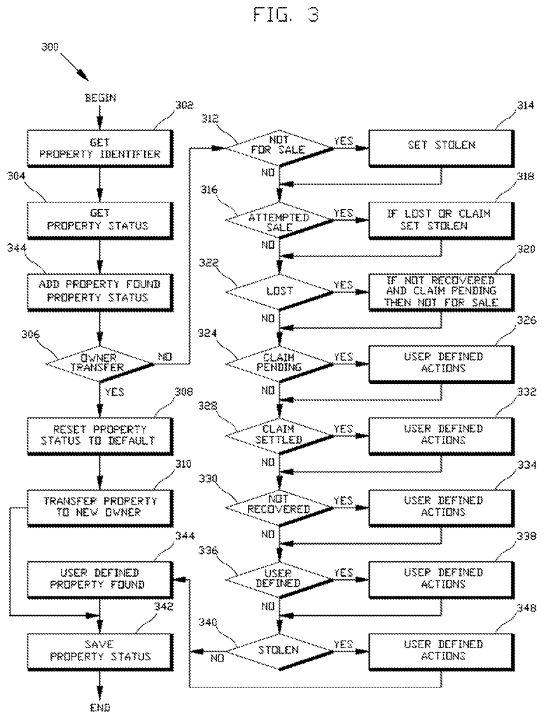

FIG. 3 illustrates a method for implementing property status to initiate preconfigured and user defined processes. A process is further disclosed to describe how property status may be used to characterize various conditions for initiating conditional responses and activities orchestrated from a property search request seeking property status. Within a search request processing means, a property identifier 302 is received for obfuscating the relationship between property, property status, and property owner. Property status 304 is also received and modified to include status for a property listing found 344. Property status 304 is comprised of a plurality of independent status states for characterizing separate conditions that can be examined and modified for initiating specific processes in response to a search request. For example, a property owner may choose to select a property listing for records transfer from one owner to another by enabling a property transfer state of property status. The new owner in property receivership generates a search request that detects property transfer status 306 to summarily reset property status 308 and initiates the property transfer 310.

In another example, property status 304 designated as property ‘not for sale’ 312 is processed to include a designation for ‘stolen’ property 314 indicating the discovery of property that could potentially be an ‘attempted sale’ 316 of property from a loss event. The search originator, having received property status within a property search means, could report an ‘attempted sale’ 316 condition when asked for more details from a property search response.

If however, an ‘attempted sale’ 316 is detected, then further examination of property status is required to satisfy a conditional logic parameter 318 for property status 304 as follows:
IF ‘attempted sale’AND IF ‘lost’ OR IF ‘claim pending’ THEN enable ‘stolen property’ 318, where property status 342 is updated to include ‘stolen property’ status 318.

In yet another example, if status for ‘lost property’ 322 is active, then further examination of property status is required to satisfy a conditional logic parameter 320 as follows:
IF ‘lost’ AND IF ‘not recovered’ AND IF ‘claim pending’ THEN enable ‘not for sale’ 320, where property status 342 is updated to include ‘not for sale’ 320.

Continuing further, if property status includes status states for ‘claim pending’ 324, or ‘claim settled’ 328, or ‘not recovered’ 330, or ‘user defined’ 336, or ‘stolen’ property 340, then further examination of property status is required to satisfy user defined conditional logic parameters for 326, 332, 334, 338, and 348, respectively, where property status 342 is updated to according user defined conditional logic parameters as specified.

In a final example for consideration, assuming property status 304 could be entirely void of information within a property listing, property status 304 is modified to include status for indicating ‘property found’ 344 for initializing conditional processes when specified. For example, a ‘user defined’ 336 status test could be configured to check status for ‘property found’ to initiate user defined processes 338, e.g., to send notifications, change property status, generate a report, or the like.

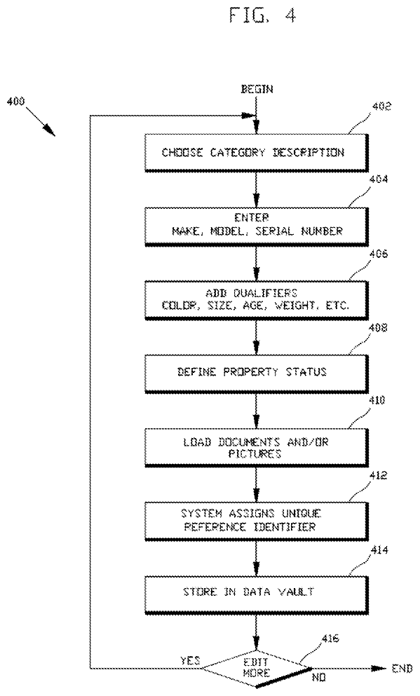

FIG. 4 illustrates a method that can be used to create a property listing for establishing property status. Searching for property status starts with an understanding of what is already known about property. Property can be described in a number of ways using familiar terms of expression common for both conveyance and understanding. Personal property can best be described in categories, such as a house, a boat, a car, a ring, a painting, and the like. As such, a property category is chosen and submitted as a searchable property descriptor 402. Furthermore, manufacturers create make, model, and serial numbers 404 for articles of property ranging from large ticket items to subcomponents of an assembly and are most useful for identifying property. Additionally, another search qualification may include terms such as color, size, age, weight, etc. 406 and therefore, well suited to identify personal property more accurately when other search parameters may not be available. A description for property status 408 provides the current property status and may be inclusive of specific property states selected by the listing property owner. Additional documents and pictures 410 may be included and secured in memory 414 in connection with a property reference identifier 412 and the entire procedure is repeated 416 until a property listing in singular or a plurality is complete.

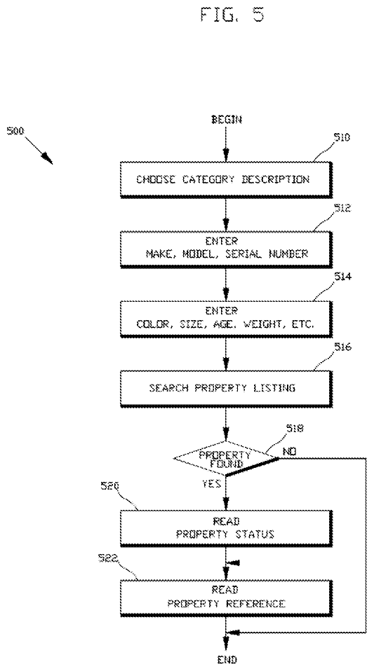

FIG. 5 illustrates a method to create a search field compatible for seeking property status of the disclosure. Comprised of a plurality of subcomponents, the search field is arranged in a specific manner to describe the inimitability of personal property that can be used in conjunction with a search means for consistent and dependable property identification. Therefore, a property description contained in a property category 510, may include a manufacturer's make, model, and serial number 512, along with any additional property qualifiers available for color, size, age, weight, etc. 514. The search field is then submitted to a search means 516 to identify registered property listings. If a listed property match is identified 518, property status 520 along with property reference 522 is returned to the initiating search process of FIG. 1.

What is claimed is:

1. A method and systems to establish property status as a configurable automated initiator of processes comprised of:
receiving property listings stored in memory, a database, or a data storage device, of a computer based processing system,
receiving property owner contact information stored in memory, a database, or a data storage device, of a computer based processing system,
receiving a search request from a web-based client, internet access and communication infrastructures to engage a property search system,
searching property listings for receiving property status;
analyzing property status stored in memory, a database, or data storage device, of a computer based processing system, extracted from separate independent property status conditions,
reconfiguring property status resulting from the analysis of property status for orchestrating response protocols, and
initiating specific processes activated through response protocols within a search process for property located in a property listing.

2. The method and systems of claim 1, wherein a process is configured to define property status, within a database, memory, or data storage means, of a computer based processing system, as a configurable component of a search process to assess property status.

3. The method and systems of claim 1, wherein a process is configured to receive property status characterizing a state of existence and status conditions for accountability, availability, and traceability, for property listed in a database, memory, or data storage means, of a computer based processing system.

4. The method and systems of claim 1, wherein a process is configured to detect property status changes within a property search process of a computer based processing system comprised of a database, memory, or data storage means, for characterizing property status derived from an accumulation of independent status conditions designed to improve search results.

5. The method and systems of claim 1, wherein a process is configured to capture and store information about personal property status discovered within a property search process designed to modify property status in a database, memory, or data storage means, of a computer based processing system.

6. The method and systems of claim 1, wherein a process is configured to process property search requests, alert property owners of property status changes, activate property recovery procedures, process owner defined actions, and transfer property records from one member account to another, initiated from property status changes discovered within a property search process designed to modify property status in a database, memory, or data storage means, of a computer based processing system.

7. A method and systems of a search process within a database, memory, or data storage means, of a computer based processing system to receive, modify, and adapt property status comprised of:
receiving property listings stored in memory, a database, or a data storage device, of a computer based processing system,
receiving property owner contact information stored in memory, a database, or a data storage device, of a computer based processing system,
receiving a search request from a web-based client, internet access and communication infrastructures to engage a search system,
searching property listings for receiving property status;
analyzing property status stored in memory, a database, or data storage device, of a computer based processing system, extracted from separate independent property status conditions,
reconfiguring property status resulting from the analysis of property status for orchestrating response protocols, and
initiating specific processes activated through response protocols within a search process for property located in a property listing.

8. The method and systems of claim 7, wherein a process to detect property status changes in response to a characterization of property status derived from an accumulation of independent status conditions designed to improve a search result.

9. The method and systems of claim 7, wherein a process to generate search results in response to a characterization of property status derived from an accumulation of independent status conditions.

10. The method and systems of claim 7, wherein a process to initiate specific processes in response to a characterization of property status derived from an accumulation of independent property status conditions.

11. The method and systems of claim 7, wherein a process to locate, capture, and store, information about property status for responding to search requests, alerting property owners of changes in property status, activating property recovery procedures, processing owner defined actions, and transferring property records from one member account to another, initiated from property status changes.

12. The method and systems of claim 7, wherein a process to obfuscate the association between property and property owners through a property reference to denote a relationship between property listings, property status, and property owners.

13. A method and systems to manage personal property information to receive, modify, and process property status comprised of:
receiving property listings stored in memory, a database, or a data storage device, of a computer based processing system,
receiving property owner contact information stored in memory, a database, or a data storage device, of a computer based processing system,
receiving a search request from a web-based client, internet access and communications infrastructure to engage a search system,
searching property listings for receiving property status;
analyzing property status stored in memory, a database, or data storage device, of a computer based processing system, extracted from separate independent property status conditions,
reconfiguring property status resulting from the analysis of property status for orchestrating response protocols, and
initiating specific processes activated through response protocols within a search process for property located in a property listing.

14. The method and systems of claim 13, wherein a process receives a property listing database.

15. The method and systems of claim 13, wherein a process receives a property owner contact database.

16. The method and systems of claim 13, wherein a process receives a search request.

17. The method and systems of claim 13, wherein a process searches the property listing database for property status.

18. The method and system of claim 13, wherein a process to detect property status changes in response to property status derived from separate independent status conditions.
